(19) United States
(12) Patent Application Publication
(10) Pub. No.: US 2024/0036589 A1
(43) Pub. Date: Feb. 1, 2024

(54) SYSTEM WITH COMMAND LOOPING SATURATION AND AUTOPILOT HEADING

(71) Applicant: SEAKEEPER, INC., California, MD (US)

(72) Inventor: Michael Gallagher, Cleveland, OH (US)

(21) Appl. No.: 18/227,698

(22) Filed: Jul. 28, 2023

Related U.S. Application Data
(60) Provisional application No. 63/393,493, filed on Jul. 29, 2022.

(51) Int. Cl. G05D 1/08; B63H 25/38

(52) U.S. Cl. CPC G05D 1/0875; B63H 25/382; B63H 2025/384

(57) ABSTRACT

A stability control system configured for total vessel pitch axis control by fast symmetric deployment of devices, coupled with engine trim adjustments and total roll and heading control by differentially deploying devices to counter rolling motions while simultaneously adjusting engine steering position to counter the steering moment associated with device delta position. The system includes a software control strategy comprising (1) a command looping saturation strategy to reduce drag and/or maximize roll performance and provide real-time ride stability to deliver a consistent device delta position even when one or more devices is at their minimum possible bias; and (2) an autopilot heading strategy comprising a feedback loop with means of actuation provided by the engine steering/rudder position and at least one pair of devices capable of producing a yaw moment.

### CROSS-REFERENCE TO RELATED APPLICATION

This application claims the benefit of and priority to U.S. Provisional Application No. 63/393,493 filed Jul. 29, 2022, the contents of which are incorporated by reference.

### FIELD OF THE DISCLOSURE

The present disclosure generally relates to a stability control system for providing optimum performance and control of dynamic active motions of a marine vessel, watercraft or boat (collectively, a marine vessel for brevity). More particularly, the present disclosure is directed to an improved stability control system configured with a software driven control strategy based on command looping saturation and autopilot heading in order to control the deployment of the water engagement devices for dynamic active control of the marine vessel.

### BACKGROUND

The following terms are commonly used in the marine industry, generally as paraphrased but not absolutely defined herein: “Trim Control” generally means the control of the average angle about the lateral or pitch axis of a marine vessel, averaged over one second or more; “List Control” or “Roll Control” generally means the control of the average angle about the longitudinal or roll axis of a marine vessel, averaged over one second or more; “Yaw Control” generally means the control of the average angle about the vertical or yaw axis of a marine vessel, averaged over one second or more. A “Water Engagement Device” or “WED” means a mechanical or electromechanical device configured to generate a variable amount of lift in a marine vessel by selective engagement of the device with or into the water flow under or adjacent to a lower or transom surface of the marine vessel when the marine vessel is underway in a certain (or forward) direction or by changing the angle of attack of the device relative to the water flow during operation of a marine vessel in a forward direction. A WED can also be referred to as a Controller in the system disclosed herein and any reference to a Controller and/or a WED means the same device. A WED “delta position” means the difference between port and starboard WED deployments. “Deployment” means the selective actuation of the WED or a change in the WED angle of attack. “Roll Moment” in a marine vessel generally means the result of a force applied to the vessel that causes the vessel to rotate about its longitudinal or roll axis; “Pitch Moment” in a marine vessel generally means the result of a force applied to the vessel that causes the vessel to rotate about its lateral or pitch axis; “Yaw Moment” in a marine vessel generally means the result of a force applied to the vessel that causes the vessel to rotate about its vertical or yaw axis. For example, (1) a “Roll Moment” can be generated if the port and starboard WEDs are deployed asymmetrically in a marine vessel that may cause the vessel to roll; (2) a “Yaw Moment” can be generated when port and starboard WEDs are deployed asymmetrically which may cause a heading change; and (3) a “Pitch Moment” can be generated if the port and starboard WEDs are deployed symmetrically or if a single WED is deployed about the center of the marine vessel which may cause the vessel to pitch.

Conventional marine stabilization techniques for when a vessel is underway in a forward direction include proportional deployment of WEDs to generate a continuous lift at the transom of the vessel for trim control while allowing adjustment of the angles (e.g., along the roll, pitch and yaw axis) of the marine vessel. A few examples of commercially available WEDs—not to be considered exhaustive by any means—are interceptors, trim tabs, and fins and other similar devices that can engage the water flow in similar fashion and provide similar functionality.

An alternate marine stabilization technique for when a vessel is not underway is a gyroscopic stabilization system that, in one of the commercially available versions, generates a torque that is proportional to the rate of precession and angular momentum. In such a gyroscopic stabilization system, a torque is applied to one or more axes depending on the orientation of the spin axis and its precession angle. The amount of torque applied to the roll, pitch and/or yaw axis can be calculated as a function of angular momentum, rate of precession, angle of precession, and precession orientation of the control moment gyroscope. The system disclosed herein makes it possible to calculate the engine steering angle change (or change in the rudder position) that would counter the torque applied about the yaw axis from a control moment gyroscopic stabilization system.

Marine stabilization technologies are key to experiencing the joy of cruising over waters without the attendant random environmentally induced disturbances of the boat. These disturbances—for example, a sudden unexpected roll—can be annoying and disruptive for boaters. In the existing prior art systems, WEDs are designed and configured to control list and trim—to get the marine vessel to an average angle in the roll and pitch axis. Smaller marine vessels used in the recreational market generally have manually actuated WEDs, while larger vessels operating in the commercial space use automatic actuated WEDs to stabilize the motion. However, such prior art systems do not combine dynamic active control with engine control for complete vessel stabilization.

In addition, there are no currently available prior art recreational or commercial stability control systems that combine a software based strategy for the fast deployment of water engagement devices to counter changes in drag due to asymmetric deployment of the water engagement devices. For instance, prior art systems do not provide real-time ride stability by mitigating (fighting off) roll motions while maintaining dynamic active control of the marine vessel using a software based command looping strategy. Further, prior art systems are not generally configured with an autopilot heading strategy having a feedback loop with means of actuation provided by the engine steering/rudder position and at least one pair of trim tabs or interceptors capable of producing a yaw moment.

In view of the foregoing disadvantages of prior art systems in the relevant field of marine stabilization, there is clearly a market need for an improved stability control system of a marine vessel—a dynamic active control system (DACS) configured with a software driven command looping and autopilot heading strategy for dynamic active control of the marine vessel that overcomes the disadvantages, as discussed below.

### BRIEF SUMMARY OF THE DISCLOSURE

The present disclosure is directed to a stability control system—a dynamic active control system (DACS) —configured for simultaneous control of marine vessel motions in all three axes, namely pitch, roll and yaw by fast deployment and actuation of the WEDs. The DACS is configured with proprietary inertial sensing hardware and software in order to learn, capture and make a determination and/or predict the various motions of the marine vessel in all three axes and command deployment of the WED blades to counteract any pitch, roll, and yaw motions of the vessel as well as total vessel pitch axis control facilitated by fast symmetric deployment of WEDs—alternatively referred as Controllers in the system disclosed herein—coupled with engine trim adjustments.

A dynamic active control system (DACS) for a marine vessel comprises a software module, a plurality of sensors and a plurality of water engagement devices, wherein each of the water engagement devices includes an actuator and a blade connected to the actuator and is configured to mount adjacent a transom of the marine vessel; wherein the software module is communicatively and operatively connected to the plurality of sensors and to each water engagement device to iteratively command activation of the actuator and deployment of the blade in response thereto based on data received from the plurality of sensors and a desired setting. The software module includes a control strategy that further iteratively commands activation of the actuators to generate a water engagement device delta position when one of the water engagement devices reaches a pre-determined threshold of one of a depth of deployment of the one of the water engagement devices and a speed of deployment of the one of the water engagement devices as a function of the data received from the plurality of sensors related to a speed of the marine vessel. The pre-determined threshold of one of a depth of deployment of the one of the water engagement devices and a speed of deployment of the one of the water engagement devices is defined as a bias of the one of the water engagement devices.

In another embodiment, a method of providing a dynamic active control of a marine vessel comprises the steps of: (a) mounting a plurality of water engagement devices adjacent a transom of the marine vessel; wherein each of the water engagement devices includes an actuator and a blade connected to the actuator; (b) connecting a software module having an embedded microprocessor-based control system to (1) a plurality of sensors and (2) each of the water engagement devices; wherein the plurality of sensors comprises at least one inertial sensor; (c) commanding activation of the actuator and deployment of the blade in response thereto based on data received from the plurality of sensors and a desired setting; (d) implementing a command looping saturation control strategy within the software module including further activation of the actuators to generate a steady water engagement device delta position when one of the water engagement devices reaches a pre-determined level of bias and measuring data received from the at least one inertial sensor that is representative of motion of the vessel; and (e) implementing further the command looping saturation control strategy within the software module to iteratively (1) one of reduce drag and maximize a roll performance of the marine vessel and (2) provide real-time stability of the marine vessel based on the measuring step.

In another embodiment, the DACS is configured to provide total vessel roll axis and heading control by differentially deploying WEDs to counter rolling motions while simultaneously adjusting engine steering (or rudder) position to counter the steering moment associated with differentially deployed WEDs. In alternative embodiments, WEDs can be referred herein as Controllers and/or vice versa in the DACS disclosed herein. The novel DACS disclosed herein can (1) simultaneous control of motions in all three axes (total vessel pitch axis control) by fast symmetric deployment of WEDs, coupled with engine trim adjustments; (2) provide total roll and heading control by differentially deploying WEDs to counter rolling motions while simultaneously adjusting engine steering position to counter the steering moment associated with WED delta position; and (3) adjust the engine steering angle to counter yaw moments produced by gyroscopic stabilization systems. As disclosed herein, a total pitch axis control strategy includes symmetric deployment of a plurality of WEDs at a deployment speed of 100 mm/s or more while simultaneously adjusting an engine trim actuator. Similarly, a total roll and heading control strategy includes a differential deployment of the plurality of WEDs at a deployment speed of at 100 mm/s or more to counter a measured rolling motion while simultaneously adjusting a steering actuator to counter a measured yaw motion resulting from the differential deployment and adjusting the steering actuator to counter the measured yaw motion generated by a gyroscopic stabilization device adapted to be installed within the marine vessel.

In another embodiment, the DACS provides for automatically adjusting the engine steering angle to counter drag moment from a WEDs asymmetrically disposed delta position—the difference between port and starboard WED deployments. The DACS comprises an embedded microprocessor based software module located within an operational console—the software module communicatively and operatively connected to the engine (via the engine control module) of the marine vessel. The software module can be configured to connect with third-party systems—e.g., navigational system—to connect and exchange data and information. At least one actuator—a component of the water engagement device (WED actuator)—is digitally communicatively and operatively connected to the software module—the WED is configured to read a signal input from the software module and automatically generate WED delta position changes to counter the roll motion resulting from a steering position change.

As further explained herein, the DACS comprises an engine having an embedded engine control module communicatively and operatively connected to the software module and a plurality of WED actuators adapted to be mounted on a transom of the marine vessel and communicatively and operatively connected to the software module. During operation of the marine vessel, the software module is further configured to send a signal in order to command a desired WED delta position and combat dynamic motions of the marine vessel. In addition, the software module is further configured to measure the relationship between an engine steering angle and the WED delta position and provide a signal output to the WED actuator. Specifically, the software module provides a first signal output to the plurality of WED actuators to command a WED delta position in order to combat dynamic motions of the marine vessel. Further, the software module measures a relationship between an engine steering angle and the water engagement device delta position and, in response thereto, provides a second signal output to the plurality of water engagement device actuators. On receiving the second signal the plurality of water engagement device actuators, in response thereto, automatically generate a change in the water engagement device delta position to counter a roll motion resulting from a steering position change.

In another embodiment, the software module is further configured with a Safe Blade Deployment Limit (SBDL) control strategy—a smart control strategy using proprietary control software combined with hardware—the SBDL configured to limit the maximum depth of deployment and/or speed of deployment of the water engagement devices—also known as the bias—as the marine vessel accelerates or decelerates, as further described in the detailed disclosure below. The SBDL is further configured to keep the deployment (depth/speed) bias static within a certain limited configuration (e.g., related to the speed of the marine vessel) until the speed of the marine vessel is reduced to a pre-determined number—for example, until the speed of the vessel is at 5 mph.

The software module is embedded with a microprocessor-based control system, the software module is further communicatively and operatively connected to a plurality of sensors. In another embodiment, the plurality of sensors can be integrated (embedded) within the software module. A gyroscopic stabilization device adapted to be disposed on the marine vessel and communicatively and operatively connected to the software module is further provided within the system. During operation of the marine vessel, the control system measures motion of the marine vessel by the inertial sensor and provides a signal output to a steering actuator to adjust a steering position automatically (a) in response to a yaw axis motion measured by the inertial sensor, and (b) based on an empirical estimate of a yaw torque generated by the gyroscopic stabilization device and a water engagement device delta position commanded by the control system, respectively, in order to counter a measured change of an output from the steering position sensor.

The software module is further connected to a distribution module—the distribution module configured as a pass through module/device for wiring installation and providing a connection and distribution point for the various components of the DACS. The software module is further communicatively coupled to (1) a plurality of sensors (e.g., motion sensors positioned within the marine vessel); (2) a pair of actuators mounted adjacent the transom to deploy and retract the WEDs; and (3) an engine (or a propulsion unit) having an embedded engine-control unit (ECU) for providing adjustable trim, height and/or steering position/direction control; and/or (4) a gyroscopic stabilization device. The plurality of sensors comprises of at least one of the following: multi-axis inertial sensor for measuring rates or acceleration generated along multiple vector axes during the operation of the marine vessel; accelerometer sensor for measuring the longitudinal acceleration, lateral acceleration and vertical acceleration of the marine vessel respectively; Roll Rate Sensor (RRS), Pitch Rate Sensor (PRS) and Yaw Rate Sensor (YRS) to measure the roll rate, pitch rate and yaw rate of the marine vessel respectively. Further, at least one sensor, from the plurality of sensors is configured to measure data related to the WEDs/Controller retraction and deployment and measure and report data on steering angle, trim position, height of the engine during the vessel operation.

The software module may be further configured with proprietary machine learning/artificial intelligence algorithm for automatic optimization of the vessel operating characteristics and to predict motion and respond instantaneously to eliminate any undesirable vessel movements that are annoying, disruptive and uncomfortable for the operators or passengers of the vessel before they are felt by an operator. The artificial intelligence-based system is configured to learn how the boat is behaving in all three axes and automatically command deployment of the WEDs and/or adjustment of the engine trim, height and/or steering to counteract the pitch, roll, and/or yaw of the vessel for a perceived stable and controlled operation. Further, the AI-based system disclosed herein can make any necessary adjustment to the engine steering position to control the heading of the marine vessel.

During operation of the marine vessel, the software module may receive a signal (about the WED delta position), make a decision on what action is needed and then send a signal to the actuator to take that action—for example, counter the rolling motions and simultaneously adjust engine steering position to counter the steering moment associated with WED delta position. As disclosed herein, the system via the plurality of sensors located throughout the marine vessel (integrated or communicatively and operatively coupled to the software module) is capable of receiving the steering position from the engine via a digital communications bus and calculating the change of steering position across a certain timeline, relating the change in steering/rudder position to a change in roll angle and automatically adjusting the WED delta position as a result of this predicted change in roll angle.

In yet another embodiment, the DACS is further configured with a software based control strategy—the software module configured with a command looping saturation strategy in order to reduce drag and/or maximize roll performance of the marine vessel. As further explained in the detailed disclosure, the software module is configured with a command looping saturation strategy in order to reduce drag and/or maximize roll performance and provide real-time ride stability in order to make it possible to deliver a consistent WED delta position even when one or more WEDs is at their minimum possible bias. In addition, the DACS software module is further configured with an autopilot heading strategy comprising a feedback loop with means of actuation provided by the engine steering/rudder position and the at least one pair of water engagement device actuators capable of producing a yaw moment.

In addition to the software module, the operational console comprises an optional multifunctional display unit and/or an operation input device (e.g., keypad)—the components communicatively and operatively connected to each other via digital communication buses. In another embodiment, the operational console functions as a control station for the operator of the marine vessel and can support a steering wheel, control lever or other similar devices or steering mechanism—other types of wheel, joystick, to maneuver the marine vessel. The software module communicatively coupled to the WEDs (or controllers) is further configured to a provide power, communications and/or data to the ECU, and the actuators for fast deployment of the WEDs.

In another embodiment, the DACS comprises an actuator having at least one WED mounted on the transom of the marine vessel and digitally connected to the software module. The system is capable of determining a desired WED delta position to combat dynamic motions of the marine vessel by measuring the relationship between an engine steering angle and the WED delta position, and monitoring and reading any data related to the WED delta position as an impending change in yaw rate, heading and roll angle of the marine vessel. Specifically, the system can (A) make the necessary adjustment to the engine steering angle to in order control the heading of the marine vessel and counter the resulting heading change from WED delta position; and (B) measure a change in steering position and predict the resulting roll motion generated from the steering position change, and automatically create WED delta position to counter the roll motion that will ultimately result from the steering position change.

As further described in the detailed disclosure, the DACS may be configured to provide total vessel yaw axis control to combat dynamic motions of the marine vessel in the yaw axis by monitoring measured yaw rates and differentially deploying the WEDs while simultaneously adjusting such deployment in response to a measured yaw rate to reduce the measured yaw rate. The system herein receives an operator command—a desired trim angle—and can (A) adjust the average positions of the WEDs as well as the engine trim angle in an effort to achieve the operator's desired trim angle; and (B) adjust the relationship between engine trim and WED average position to optimize either the performance of the DACS system or fuel efficiency of the engine of the marine vessel.

The DACS may be configured to monitor and read any data related to the differential deployment of the WEDs as an impending change in the yaw rate, heading and roll rate of the marine vessel. Based on the data received, the system can provide total roll axis and heading control by differentially deploying WEDs to counter roll axis moments while simultaneously adjusting engine steering position to counter the steering moment associated with differential controller deployment. The DACS may also be configured to adjust the engine steering angle to counter yaw moments produced by gyroscopic stabilization systems.

Certain embodiments are shown in the drawings. However, it is understood that the present disclosure is not limited to the arrangements and instrumentality shown in the attached drawings.

### BRIEF DESCRIPTION OF THE DRAWINGS

The accompanying drawings incorporated in and forming a part of the specification illustrate several aspects of the present disclosure and, together with the description, serve to explain the principles of the embodiments. In the drawings:

FIG. 1 illustrates an embodiment of the dynamic active control system with engine control comprising at least one pair of water engagement devices, a software module, an engine with engine control module, and a gyroscopic stabilization system connected to each other and various other modules and components according to one aspect of the present disclosure.

FIGS. 2 and 3 illustrate a fully deployed and a fully retracted water engagement device according to one aspect of the present disclosure.

FIGS. 4 and 5 illustrate a symmetrical deployment of at least one pair of water engagement devices according to one aspect of the present disclosure.

FIG. 5 illustrate a differential deployment of at least one pair of water engagement devices according to one aspect of the present disclosure

FIG. 6 illustrates a command looping saturation strategy according to one aspect of the present disclosure.

### DETAILED DESCRIPTION OF THE DISCLOSURE

For the purposes of promoting and understanding the principles disclosed herein, reference is now made to the preferred embodiments illustrated in the drawings, and specific language is used to describe the same.

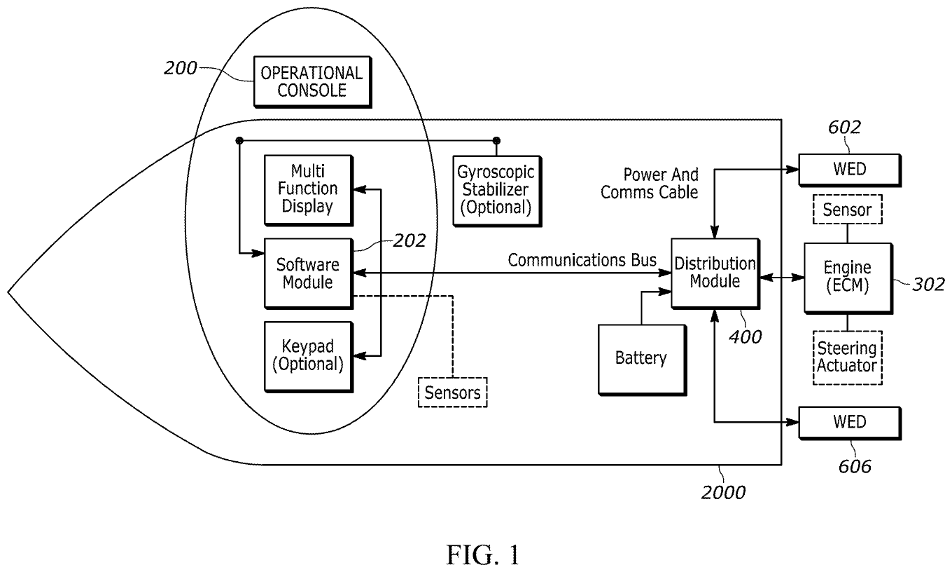

As illustrated in FIG. 1, the marine vessel 2000 comprises the DACS 1000 having a software module 202 within an operational console 200 and/or mounted near the helm of the marine vessel 2000. The software module 202 is communicatively coupled to an engine having an embedded engine-control module 302 and a distribution module 400 located near the transom of the marine vessel 2000 and primarily used for supplying power and communication signals to the various components of the DACS 1000. The operational console 200 functions as a control station for the operator of the marine vessel and can support a steering wheel, control lever or other similar devices to steer and/or maneuver the marine vessel 2000. The software module 202 communicatively connected to the engine-control module 302 and configured to run the various operational algorithms for dynamic active control of the marine vessel 2000 provides for adjustable trim, height and/or steering position/direction control of the engine. As further illustrated in FIG. 1, the operational console 200, in addition to the software module 202 can include an optional multifunctional display unit 202 and/or an operation input device 204 (e.g., keypad)—the components communicatively and operatively connected to each other via digital communication buses.

Referring back to FIG. 1, the software module 202 includes a memory, and an embedded programmable processor configured to read data on a vessel's performance characteristics from the memory and provide data to the processor in order to run various operational algorithms for dynamic active control of the marine vessel 2000. For example, any data related to operational performance of the marine vessel (e.g., data related to critical failure of the system or a component of the marine vessel) can be stored within the memory of the software module 202. A plurality of sensors are communicatively and operatively connected with the software module 202. As shown, the software module 202 is communicatively and operatively coupled to (1) a plurality of sensors (e.g., motion sensors positioned within the marine vessel); (2) at least one pair of actuators mounted adjacent the transom of the vessel 2000 to deploy and retract the WEDs 602, 606; and/or (3) a gyroscopic stabilizer 500. In another embodiment, additional WEDs—for instance, two pairs of WEDs with actuators mounted adjacent the transom of the vessel 2000 configured to deploy and retract—which can also be referred to as WEDs are substantially same in structure and functions in substantially the same manner. In another embodiment, the plurality of sensors may be integrated or embedded within the software module 202. Further, at least one sensor, from the plurality of sensors, is configured to measure data related to the retraction and deployment of each of the WED/Controller (602, 606) and to measure and report data on steering angle, trim position, height of the engine during the vessel operation.

The software module 202—communicatively coupled to the engine control module 302 of the engine of the marine vessel 2000—is further configured to a provide power, communications and/or data to the actuators for fast deployment of the WEDs 602, 606. Further, as illustrated in FIG. 1, the software module 202 can be connected to other peripheral devices via digital communication buses—additional sensors (e.g., a GPS sensor, voltage sensors, encoders, current sensors, temperature sensor and/or other sensors)—the software module 202 primarily responsible for measuring, feeding data to the engine control module 302 and/or the actuators connected to the WEDs 602, 606 and measuring and computing various performance characteristics for dynamic active control of the marine vessel 2000.

As illustrated in the DACS 1000 disclosed herein, the distribution module 400 may be mounted and located in proximity to the transom of the marine vessel 2000 wherein the operational console 200 (including the software module 202) may be mounted near the helm and not in proximity to the transom of the marine vessel 2000. The various modules are communicatively coupled to each other—specifically the engine control module 302, the software module 202, and the actuators for the WEDs (602, 606)—via industry standard power and communication cables. The WED may be mounted on or near the transom of the marine vessel—the WED actuator may be configured to provide fast deployment of the WEDs in 100 mm/s or more (mm/s)—preferably faster than 250 mm/s. During operation of the marine vessel 2000, the system 1000 is further designed to generate signals—for example, a wake signal—for the software module 202 to communicate a “power on” (wake up) status to the various components of the system—namely, the engine-control module 302 and other components (displays, input devices etc.) of the operational console 200 and the actuators for fast deployment of the WEDs 602, 606.

Referring back to FIG. 1, the software module 202 is further configured to store and display certain information (e.g., route maps, chart plot, etc.) and provide reliable marine navigation and guidance to an operator of the marine vessel 2000. Such navigation and guidance include provisions for connecting to certain OEM-specific Internet Protocol (IP) for network interface identification and location addressing, and to provide easy-to-use User Interface (UI) for vessel operators. For instance, the software module 202 can provide yaw and trim correcting information/commands to the engine and steering system to prevent the marine vessel from deviating from the present course. The software module 202 is primarily an embedded computing device running a certain type of Linux or other operating system providing equivalent functionality. As mentioned above, the system 1000 also includes an additional number of user input devices, such as a keypad, a steering wheel and one or more throttle/shift levers. Each of the devices communicatively connected to the software module 202 are configured to provide commands (input signal) to the processor—the processor in turn, communicates with the actuator associated with the respective WED (602, 606) via the actuator power and communications cable—as shown in FIG. 1—and provides instructions to the actuator for fast deployment of the WEDs/Controllers 602, 606.

The software module 202 further comprises a plurality of multi-axis inertial sensors for measuring rates or acceleration generated along multiple vector axes during the operation of the marine vessel 2000. The software module 202 is configured to be communicatively and operatively connected to the plurality of multi-axis inertial sensors—including, for example, the accelerometer sensors for measuring accelerations along the x, y and z axes (longitudinal acceleration, lateral acceleration and vertical acceleration), sensors to measure the roll rate, pitch rate and yaw rate—Roll Rate Sensor (RRS), Pitch Rate Sensor (PRS) and Yaw Rate Sensor (YRS), respectively. This disclosure also include embodiments that include 6-axis, 9-axis or magnetometer sensors or other similar sensors for various measurements—e.g., rates, accelerations, forces, torques etc.—generated during the dynamic active control of the vessel. The software module 202 communicatively connected to the WEDs 602, 606 can be programmed to act (make certain iterative decisions) based on information received from an attitude sensor (e.g., pitch and roll) as well as from a global positioning system (GPS) sensor located at a pre-selected fixed position on the marine vessel 2000.

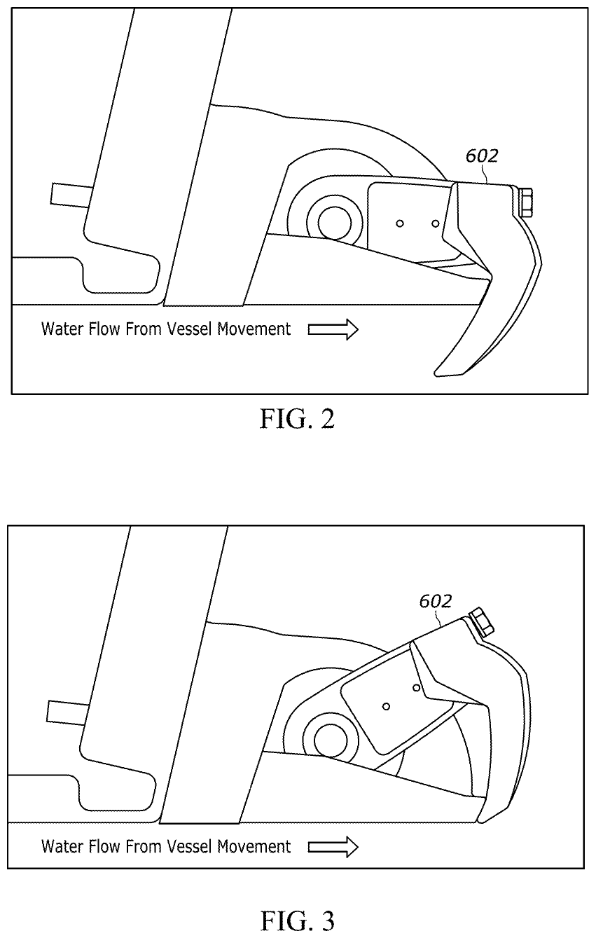

Referring back to FIG. 1, the DACS 1000 comprises at least one pair of WEDs mounted on the transom of the marine vessel 2000 and configured for fast deployment of the WEDs 602, 606—the system 1000 providing total vessel pitch axis control by fast symmetric deployment of the WEDs 602, 606 coupled with engine trim adjustments. As illustrated, the WEDs 602, 606 mounted on the transom of the vessel 2000 and configured for fast deployment into the water at 100 mm/s or more —preferably faster than 250 mm/s. FIGS. 2 and 3 illustrate a fully deployed and a fully retracted water engagement device according to one aspect of the present disclosure.

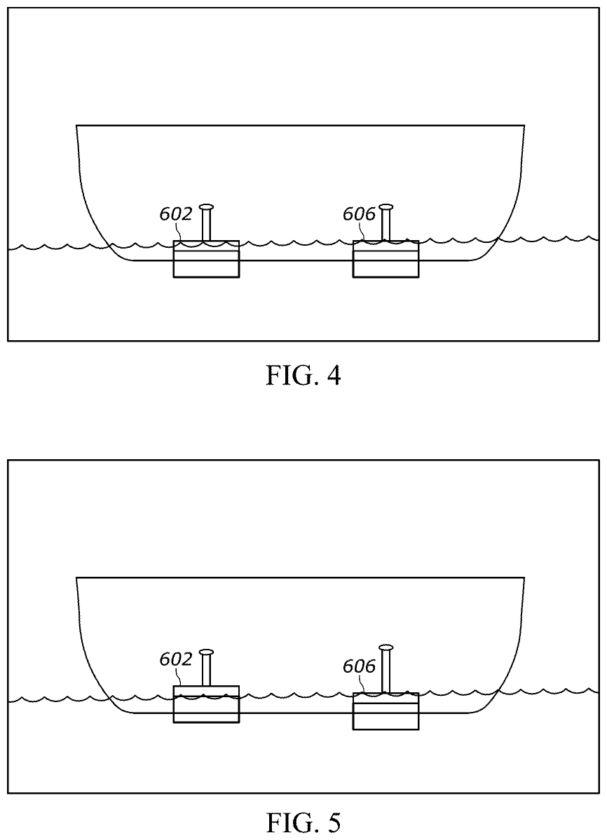

As illustrated in FIG. 4, the DACS 1000 is also configured to provide total vessel pitch control by symmetric deployment of the WEDs 602, 606 coupled with engine trim adjustment and providing optimum stability control of the vessel. For instance, if the WED 602 is halfway (50 percent) down, a sensor can send a signal to the software module 202 which in turn can command the actuator attached to the WED 602 to make adjustments both in the up and down positions for the WED 602. The DACS 100 can further optimize the relationship between the WED bias and the engine trim to deliver the best-case dynamic active control for the marine vessel. As further illustrated in FIG. 5, the system 1000 is further configured to provide total roll and heading control by differentially deploying WEDs 602, 606 to (1) counter rolling motions while simultaneously adjusting any engine steering position to counter the steering moment associated with WED delta position; and (2) providing adjustment of the engine steering angle to counter yaw moments produced by gyroscopic stabilization systems. The software module 202 comprising various algorithms running a proportional-integral-derivative control loop (PID) for continuously capturing data related to the difference between the commanded roll angle and the measured roll angle—the delta angle—and applying a responsive and accurate correction on the delta position between the WEDs 602 and 606 on the port and starboard sides of the marine vessel 2000 respectively (as shown in FIGS. 4 and 5).

In another aspect of the present disclosure, during operation of the marine vessel 2000, the system 1000 continuously monitors and measures data/feedback from the sensors and send command signals to instruct the actuator systems for fast deployment of WEDs 602, 606 to counteract certain dynamic active motions of the marine vessel (e.g., motions in the 0-3 Hz frequency spectrum across the roll, yaw and pitch axes) and provide the required dynamic active control of the marine vessel.

In another aspect of the present disclosure, DACS 1000 as disclosed herein is configured to make the necessary adjustment to the engine steering angle to control the heading of the marine vessel 2000 and counter the resulting heading change resulting from WED delta position. The DACS 1000 can measure a change in steering position and predict the resulting roll motion generated from the steering position change while automatically generating WED delta position to counter the roll motion that will ultimately result from this steering position change.

In another aspect of the present disclosure, the DACS 1000 is configured to adjust the vessel 2000 trim angle by symmetric deployment (shown in FIG. 4) of the WEDs 602, 606 coupled with engine trim adjustment. Controlling the engine trim adjustment gives the operator and/or the system the opportunity to optimize fuel efficiency or stabilization performance of the marine vessel 2000. The performance of the marine vessel 2000 is further optimized, by the DACS guaranteeing that the WEDs 602, 606 will maintain an average, non-zero position (or “bias”) and adjusting the engine trim to enable the bias. In addition, the DACS 1000 is configured to optimize the engine trim for fuel efficiency purposes by delivering the commanded trim, even if that action results in less than optimum DACS performance.

In yet another aspect of the present disclosure, the software module 202 is further configured with a Safe Blade Deployment Limit (SBDL) control strategy —configured to read and interpret data from a marine vessel acceleration/deceleration vs. blade deployment curve, the contents of which are embedded within the proprietary programs of the software module 202. As discussed above, the software module includes a control strategy that further iteratively commands activation of the actuators to generate a water engagement device delta position when one of the water engagement devices reaches a pre-determined threshold of one of a depth of deployment of the one of the water engagement devices and a speed of deployment of the one of the water engagement devices as a function of the data received from the plurality of sensors related to a speed of the marine vessel.

The smart proprietary control software strategy primarily drives the SBDL to continuously read, measure and interpret the data—in a continuous loop—and control or limit the depth of deployment and/or speed of deployment—the bias—of the water engagement devices at various speeds during operation of the marine vessel. The novel and unique SBDL can vary bias if the vessel 2000 is accelerating or decelerating by controlling the bias as a set function of the speed of the marine vessel 2000. For instance, if the vessel 2000 accelerates while traveling at a speed of 25 mph—the bias of the water engagement device could be at 1 inch. However, if the vessel 2000 decelerates while traveling at 25 mph, the SBDL could limit the bias to 0.5 inch (instead of the 1 inch).

In still yet another aspect of the present disclosure, the DACS disclosed herein provides for at least two optimization strategies by allowing the DACS to be controlled by the WED average position as well as by the engine trim. The DACS is configured to receive a desired trim angle from the operator and adjust the average positions of the WEDs as well as the engine trim angle in an effort to achieve the operator's desired trim angle. As disclosed herein, the DACS is configured to adjust the relationship between engine trim and WED average position, and optimize either the performance of the DACS system or fuel efficiency of the engine.

In another aspect of the present disclosure, during operation as the marine vessel 2000 moves through the water the system 1000 is configured to adjust the engine steering position to counter the yaw moment (by measuring the changing drag force) associated with the WEDs 602, 606 delta deployment. The software module 202 can provide a signal to the engine control module 302 of the engine for adjusting the steering position of the engine.

Referring back to FIGS. 1-5, the DACS 1000 is configured to measure the relationship between the steering position of the engine and a desired WED delta position—the difference between starboard WED and port WED and their average positions. For instance, as the WED delta position is increased, the software module 202 sends a signal to the engine control module 302 to adjust the steering position of the engine of the marine vessel 2000. The ability of the system 1000 to counter the steering moment (by measuring the changing drag force) associated with the WED's delta deployment is instrumental in providing optimized total roll and heading control, as disclosed herein.

In another embodiment, during operation of the marine vessel 2000, a total roll axis control system generates a delta position between WEDs on the port and starboard side of the vessel in order to generate an anti-rolling torque—the anti-rolling torque used to combat roll motion of the marine vessel 2000 induced by waves, weight imbalances, or other causes. During such an event, the delta position increases the deployment command for one WED (e.g., 602) and decreases the deployment command (or retracts) for the other WED (e.g., 606). The WED delta is proportional to the rolling motion and generally the more deployed the WEDs the higher is the average position of the WEDs. The generation of higher bias in turn results in reduction or decrease in the trim angle of the marine vessel 2000. In certain situations, during boating, an operator might want the highest possible trim angle for the vessel 2000 which in turn generates the minimum possible bias command to the WEDs (602, 606). Once the WED bias is at its minimum—the controller attempts to combat rolling motions of the vessel 2000 by increasing the delta position between the WEDs on the port and starboard side. However, for optimum performance—in order to increase delta position while having the minimum possible impact on bias—one WED must increase its deployed position while the other WED must decrease its deployed position (or otherwise retract). In such a situation—the performance of the vessel 2000 could get affected. For example, when bias is already at minimum—the deployment position of the WED cannot be further decreased and thereby failing to achieve desired anti-rolling torque.

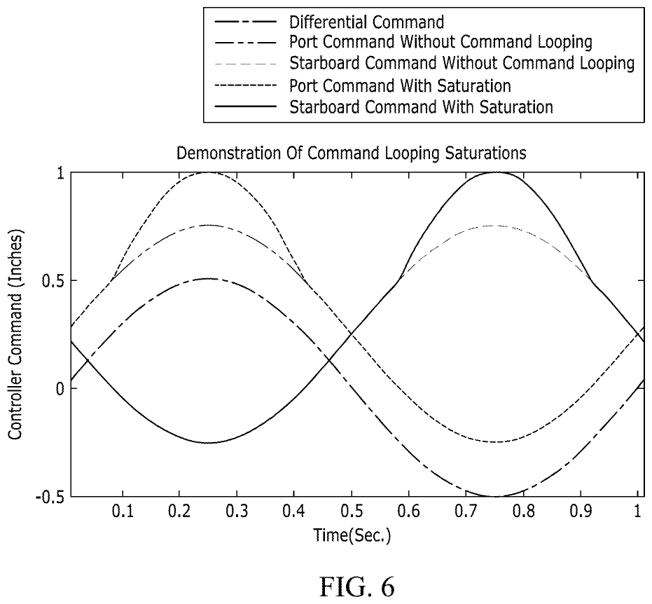

As disclosed herein, in order to overcome such drawbacks, the software module 202 is configured with a novel and unique command looping saturation strategy—Saturation Strategy—to further stabilize operation of the marine vessel 2000. The Saturation Strategy can (a) reduce drag and/or maximize roll performance; and (b) provide real-time ride marine stability by mitigating roll motions while maintaining dynamic active control of the vessel 2000, as further explained herein. The novel command looping saturation—Saturation Strategy “loops” the negative command meant for the WED at minimum position, inverts its sign, adds it to the WED that is increasing its position—the command looping saturation therefore delivering the desired WED delta position despite the minimum bias command generated for the WEDs, as shown in FIG. 6.

As further illustrated in the FIG. 6, the Saturation Strategy as part of the stability control system—the dynamic active control system—allows consistent WED delta position commands to be applied despite the fact that for the shown bias command on the port and starboard WED a negative deployment command would otherwise have resulted for one of the WEDs. The Saturation Strategy makes it possible to deliver the maximum possible trim angle without compromising on ability to deliver WED delta position. Such smart Saturation Strategy can also have an impact on drag and fuel efficiency. As disclosed herein, in this embodiment, the Saturation Strategy makes it possible to deliver the minimum possible bias (and therefore the minimum possible drag) without compromising on ability to deliver and/or generate WEDs delta position. Once activated, the software module driven Saturation Strategy can command the desired delta position for the plurality of the WEDs, determine the current delta and the water engagement devices positions, and reduce the deployment of the lesser deployed WED (or either WED if both are deployed equally) to zero if it measures that the current deployment less than the commanded delta amount. Further, if the software module continues to read the current lesser deployed actuator blade/WED position as less the commanded delta amount—the Saturation Strategy will reduce, maintain or increase the deployment of the greater (or other) deployed actuator blade/WED to achieve the commanded delta position.

The Saturation Strategy controls optimal deployment of the WEDs—from a fully deployed position (shown in FIG. 2) to a fully retractable position (shown in FIG. 3) to maintain total dynamic active control of the marine vessel. The novel Saturation Strategy provides an opportunity to have only one blade deployed in order to achieve the commanded delta position—preventing the marine vessel from becoming uncontrollable and providing a preferred mode of operation for the marine vessel 2000. Further, as disclosed above, the software module 202 is further configured with an autopilot heading strategy comprising a feedback loop with means of actuation provided by the engine steering/rudder position and the at least one pair of water engagement device actuators capable of producing a yaw moment

In another aspect of the present disclosure, the software module 202 is can receive and process data on the steering position of the engine of the marine vessel 2000. Specifically, the processor is programmed to measure the relationship between the steering position of the engine and the WED 602, 606 delta position. Based on the measured data, the software module 202 can generate and send predictive signals to the actuator to adjust the WEDs 602, 606 by differentially deploying each of the WEDs 602, 606 to counter rolling motions and simultaneously adjust the engine steering position to counter the steering moment associated with the WED delta position, as shown in FIG. 5. As further illustrated in FIGS. 4 and 5, the software module 202 can instruct the actuator mechanism to adjust the deployments of one or more of the WEDs—moving the WEDs 602, 606 (or additional WEDs) together or moving only one of the WEDs 602 or 606, or various patterned combinations of movements thereof. If more than one WED is moved, they may be moved in parallel or opposite to each other, to the deployments of the same magnitude as one another, or at different deployments, as needed simultaneously to counter unnecessary roll and pitch motions and optimize total vessel pitch axis control by fast symmetric deployment of coupled with engine trim adjustments.

In another aspect of the present disclosure, the DACS 1000 provides the operator with the option to control and change (if necessary) the commanded roll angle of the marine vessel 2000. During operation of the marine vessel 2000, if waves hit a boat on the starboard side the operator has the option to dynamically change the commanded roll angle and/or instruct the operator via the user interfaces of to tilt the boat down to the port side.

The processing and computing of the data—specifically the processing of signal by the software module 202 to change the deployment angles of the WEDs/Controllers 602, 606 based on the difference between the commanded and the actual (measured) roll angle, is one of the key innovative features of the improved DACS. An operator can change the commanded roll angle (e.g., −5 to 5 degrees) which triggers the decision loop within the control system and generates the output signal to instruct the actuator system for fast (at 100 mm/s or more) delta deployment of the WEDs 602, 606.

It is understood that the preceding is merely a detailed description of some examples and embodiments of the present disclosure, and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden. It is further understood that the scope of the present disclosure fully encompasses other embodiments that may become obvious to those skilled in the art.

Differential and differentially are defined within this document as unequal, off center and/or involving differences in: angle, speed, rate, direction, direction of motion, output, force, moment, inertia, mass, balance, application of comparable things, etc. The terms Dynamic and/or Dynamic Active Control may mean the immediate action that takes place at the moment they are needed. Any use of the term immediate, in this application, means that the control action occurs in a manner that is responsive to the extent that it prevents or mitigates vessel motions and attitudes before they would otherwise occur in the uncontrolled situation. A person of ordinary skilled in the art understands the relationship between sensed motion parameters and required response in terms of the maximum overall delay that can exist while still achieving the control objectives. Dynamic and/or Dynamic Active Control may be used in describing interactive hardware and software systems involving differing forces and may be characterized by continuous change and/or activity. Dynamic may also be used when describing the interaction between a vessel and the environment. As stated above, marine vessels may be subject to various dynamic forces generated by its propulsion system as well as the environment in which it operates. Any reference to vessel attitude may be defined as relative to three rotational axes including pitch attitude or rotation about the Y, transverse or sway axis, roll attitude or rotation about the X, longitudinal or surge axis, and yaw attitude or rotation about the Z, vertical or heave axis.

Various features of the example embodiments described herein may be implemented using hardware, software, or a combination thereof and may be implemented in one or more computer systems or other processing systems. However, the manipulations performed in these embodiments were often referred to in terms, such as determining, which are commonly associated with mental operations performed by a human operator. No such capability of a human operator is necessary in any of the operations described herein. Rather, the operations may be completely implemented with machine operations. Useful machines for performing the operation of the exemplary embodiments presented herein include general purpose digital computers or similar devices. With respect to hardware, a CPU typically includes one or more components, such as one or more microprocessors for performing the arithmetic and/or logical operations required for program execution, and storage media, such as one or more disk drives or memory cards (e.g., flash memory) for program and data storage, and a random access memory for temporary data and program instruction storage. With respect to software, a CPU typically includes software resident on a storage media (e.g., a disk drive or memory card), which, when executed, directs the CPU in performing transmission and reception functions.

The CPU software may run on an operating system stored on the storage media, such as, for example, UNIX or Windows (e.g., NT, XP, Vista), Linux, and the like, and can adhere to various protocols such as the Ethernet, ATM, TCP/IP, CAN, LIN protocols and/or other connection or connectionless protocols. As is known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include multiple separate CPUs, wherein each is dedicated to a separate application, such as, for example, a data application, a voice application, and a video application. Software embodiments of the example embodiments presented herein may be provided as a computer program product, or software, that may include an article of manufacture on a machine-accessible or non-transitory computer-readable medium (i.e., also referred to as “machine readable medium”) having instructions. The instructions on the machine-accessible or machine-readable medium may be used to program a computer system or other electronic device. The machine-readable medium may include, but is not limited to, floppy diskettes, optical disks, CD-ROMs, magneto-optical disks, USB thumb drives, and SD cards or other type of media/machine-readable medium suitable for storing or transmitting electronic instructions. The techniques described herein are not limited to any particular software configuration. They may find applicability in any computing or processing environment. The terms “machine-accessible medium,” “machine-readable medium,” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. It is to be noted that it is common—as a person skilled in the art can contemplate—in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed. It is understood that the preceding is merely a detailed description of some examples and embodiments of the present disclosure, and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden.

It is further understood that the scope of the present disclosure fully encompasses other embodiments that may become obvious to those skilled in the art. Features illustrated or described as part of one embodiment can be used in another embodiment to yield a still further embodiment. Thus, it is intended that the present disclosure cover such modifications and variations as come within the scope of the appended claims and their equivalents. It is to be understood by one of ordinary skill in the art that the present discussion is a description of exemplary embodiments only, and is not intended as limiting the broader aspects of the present disclosure, which broader aspects are embodied in the exemplary constructions.

1. A dynamic active control system for a marine vessel comprising:
a software module, a plurality of sensors and a plurality of water engagement devices,
wherein each of the water engagement devices includes an actuator and a blade connected to the actuator and is configured to mount adjacent a transom of the marine vessel;
wherein the software module is communicatively and operatively connected to the plurality of sensors and to each water engagement device to iteratively command activation of the actuator and deployment of the blade in response thereto based on data received from the plurality of sensors and a desired setting; and
wherein the software module includes a control strategy that further iteratively commands activation of the actuators to generate a water engagement device delta position when one of the water engagement devices reaches a pre-determined threshold of one of a depth of deployment of the one of the water engagement devices and a speed of deployment of the one of the water engagement devices as a function of the data received from the plurality of sensors related to a speed of the marine vessel.

2. The system of claim 1, wherein
the control strategy is configured to further iteratively commands activation of the actuators to generate a maximum trim angle without changing the water engagement device delta position.

3. The system of claim 1, wherein pre-determined threshold of one of a depth of deployment of the one of the water engagement devices and a speed of deployment of the one of the water engagement devices is defined as a bias of the one of the water engagement devices.

4. The system of claim 1, further comprising:
an adjustable steering position control embedded within the engine control module wherein the software module is further configured to (a) provide a first signal output to the plurality of water engagement device actuators to command a water engagement device delta position in order to combat dynamic motions of the marine vessel; and (b) measure a relationship between the water engagement device delta position and, in response thereto, provides a second signal output to the plurality of water engagement device actuators;
wherein the plurality of water engagement device actuators receive the second signal output and, in response thereto, automatically generate a change in the water engagement device delta position to counter a roll motion resulting from a steering position change.

5. The system of claim 3, wherein the bias is a minimum bias associated with a change in speed of the marine vessel.

6. The system of claim 1, wherein the software module comprises at least one embedded microprocessor and the control strategy is implemented by a command looping saturation control algorithm comprising at least one set of program instructions; and wherein the at least one embedded microprocessor is further configured to run the at least one set of program instructions in order for the software module to iteratively read, interpret and manipulate data associated with the operation of the marine vessel.

7. The system of claim 6, wherein the command looping saturation control algorithm is enabled to read input from an operator and automatically command a desired delta position for the at least one pair of water engagement devices by iteratively (a) determining the current delta position of the at least one pair of water engagement devices and (b) changing the deployed position of the at least one of the water engagement devices from the at least one pair of water engagement devices in order to align the deployment of the at least one pair of water engagement devices to the command generated from the input of the operator.

8. The system of claim 7, wherein the operator input comprises of a delta command and the change in the deployed position of the at least one of the water engagement devices from the at least one pair of water engagement devices comprises maintaining, increasing or reducing the deployed position in response to the delta command.

9. The system of claim 8, wherein the at least one set of program instructions of the command looping saturation control algorithm is configured and enabled to iteratively:
(a) loop any reading of a negative command data generated for a minimum bias of the at least one pair of water engagement devices;
(b) invert the sign of the negative command data and convert it to a positive command data; and
(c) add the converted positive command data to the at least one of the water engagement devices from the at least one pair of water engagement devices that is attempting to increase its deployed position in response to the operator command.

10. A method of dynamic active control of a marine vessel, the method comprising the steps of:
mounting a plurality of water engagement devices adjacent a transom of the marine vessel, wherein each of the water engagement devices includes an actuator and a blade connected to the actuator;
connecting a software module having an embedded microprocessor-based control system to (1) a plurality of sensors and (2) each of the water engagement devices, wherein the plurality of sensors comprises at least one inertial sensor;
commanding activation of the actuator and deployment of the blade in response thereto based on data received from the plurality of sensors and a desired setting; and
implementing a command looping saturation control strategy within the software module including further activation of the actuators to generate a steady water engagement device delta position when one of the water engagement devices reaches a pre-determined level of bias;
measuring data received from the at least one inertial sensor that is representative of motion of the vessel; and
implementing further the command looping saturation control strategy within the software module to iteratively (a) one of reduce drag and maximize a roll performance of the marine vessel and (b) provide real-time stability of the marine vessel based on the measuring step.

11. The method of claim 10, wherein the level of bias is a threshold of one of a depth of deployment of the one of the water engagement devices and a speed of deployment of the one of the water engagement devices as a function of the data received from the plurality of sensors related to a speed of the marine vessel.

12. The method of claim 10, further comprising:
embedding an adjustable steering position control within the engine control module;
providing a first signal output to the plurality of water engagement device actuators to command a water engagement device delta position in order to combat dynamic motions of the marine vessel;
measuring a relationship between the water engagement device delta position and, in response thereto, provides a second signal output to the plurality of water engagement device actuators; and
receiving the second signal output by the plurality of water engagement device actuators and, in response thereto, automatically generating a change in the water engagement device delta position to counter a roll motion resulting from a steering position change.

13. The method of claim 10, wherein the command looping saturation control strategy is enabled to read input from an operator and automatically command a desired delta position for the at least one pair of water engagement devices by iteratively (a) determining the current delta position of the at least one pair of water engagement devices and (b) changing the deployed position of the at least one of the water engagement devices from the at least one pair of water engagement devices in order to align the deployment of the at least one pair of water engagement devices to the command generated from the input of the operator.

14. The method of claim 13, wherein the operator input comprises of a delta command and the change in the deployed position of the at least one of the water engagement devices from the at least one pair of water engagement devices comprises maintaining, increasing or reducing the deployed position in response to the delta command.

15. The method of claim 14, wherein the at least one set of program instructions of the command looping saturation control strategy is configured and enabled to iteratively:
(a) loop any reading of a negative command data generated for a minimum bias of the at least one pair of water engagement devices;
(b) invert the sign of the negative command data and convert it to a positive command data; and
(c) add the converted positive command data to the at least one of the water engagement devices from the at least one pair of water engagement devices that is attempting to increase its deployed position in response to the operator command.

16. A dynamic active control system, the system comprising:
a marine vessel, a software module, a plurality of sensors and a plurality of water engagement devices,
wherein the plurality of water engagement devices are connected to the marine vessel adjacent a transom of the marine vessel,
wherein each of the water engagement devices includes an actuator and a blade connected to the actuator,
wherein the software module is communicatively and operatively connected to the plurality of sensors and to each water engagement device to iteratively command activation of the actuator and deployment of the blade in response thereto based on data received from the plurality of sensors and a desired setting,
wherein the software module includes a control strategy that iteratively generates a consistent water engagement device delta position when at least one of the water engagement devices is disposed at a pre-determined level of bias, and
wherein the software module further includes an autopilot heading control strategy including a feedback loop and an actuator connected to an engine in communication with an engine control.

17. The system of claim 16, wherein the control strategy comprises a command looping saturation control algorithm enabled to read input from an operator and automatically command a desired delta position for the at least one pair of water engagement devices by iteratively (a) determining the current delta position of the at least one pair of water engagement devices and (b) changing the deployed position of the at least one of the water engagement devices from the at least one pair of water engagement devices in order to align the deployment of the at least one pair of water engagement devices to the command generated from the input of the operator.

18. The system of claim 17, wherein the command looping saturation control algorithm is configured and enabled to iteratively:
(a) loop any reading of a negative command data generated for a minimum bias of the at least one pair of water engagement devices;
(b) invert the sign of the negative command data and convert it to a positive command data; and
(c) add the converted positive command data to the at least one of the water engagement devices from the at least one pair of water engagement devices that is attempting to increase its deployed position in response to the operator command.

19. The system of claim 18, the system further comprising
a total pitch axis control strategy including symmetric deployment of a plurality of water engagement devices at a deployment speed of at least 100 mm/s while simultaneously adjusting an engine trim actuator;
a total roll and heading control strategy including a differential deployment of the plurality of water engagement devices at a deployment speed of at least 100 mm/s to counter a measured rolling motion while simultaneously adjusting a steering actuator to counter a measured yaw motion resulting from the differential deployment and adjusting the steering actuator to counter the measured yaw motion generated by a gyroscopic stabilization device adapted to be installed within the marine vessel;
wherein the software module is further configured and enabled with a command looping saturation control algorithm in order to iteratively (a) reduce drag and/or maximize the roll performance of a marine vessel and (b) provide real-time ride stability of the marine vessel by delivering consistent water engagement device delta position when at least one of the water engagement devices is at a certain pre-determined bias; and
wherein the software module is further configured and enabled with a an autopilot heading control algorithm comprising a feedback loop and a means of actuation.

20. The system of claim 16, the system comprising:
a software module including an embedded microprocessor-based control system, a multi-axis rate sensor and a steering position sensor operatively connected to at least one of the water engagement devices and to the software module;
wherein the control system determines an asymmetric deployment of the at least one of the water engagement devices in response to a dynamic roll axis motion measured by the rate sensor as a result of a change in an output from the steering position sensor;
wherein the control system determines a relationship between the output from the steering position sensor and the asymmetric controller deployment; and
wherein the control system automatically commands changes to the asymmetric controller deployment to counter the dynamic roll axis motion resulting from the change in the output from the steering position sensor.
